(19) United States
(12) Patent Application Publication
(10) Pub. No.: US 2015/0213148 A1
(43) Pub. Date: Jul. 30, 2015

(54) SYSTEMS AND METHODS FOR BROWSING

(71) Applicant: Jeffrey Blemaster, Los Angeles, CA (US)

(72) Inventor: Jeffrey Blemaster, Los Angeles, CA (US)

(21) Appl. No.: 14/605,899

(22) Filed: Jan. 26, 2015

Related U.S. Application Data
(60) Provisional application No. 61/932,250, filed on Jan. 28, 2014.

(51) Int. Cl. G06F 17/30; G06F 3/0483; G06F 3/0484

(52) U.S. Cl. CPC G06F 17/30899; G06F 3/04842; G06F 3/0483

(57) ABSTRACT

Systems and methods for browser navigation are provided. After a browser has navigated from a first webpage to a second webpage, the first webpage containing a plurality of links including a link to the second webpage, the browser detects that a user has activated a first multitask browser control while the browser is displaying the second webpage in a first window. In response to detecting that the user has activated the first multitask browser control while the browser is displaying the second webpage in the first window, the browser causes the first webpage to be displayed in the first window, and causes the second webpage to be loaded in a second window.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference in their entirety under 37 CFR 1.57.

### BACKGROUND OF THE INVENTION

1. Field of the Invention

The present invention is related to browsing documents.

2. Description of the Related Art

A browser is an application configured to retrieve, present and traverse information resources, such as webpages, images, or other documents, which may be accessed over a network, such as the Internet. Conventional browsers are typically equipped with a conventional back control which merely enables a user to instruct the browser to navigate back to a previous resource.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect of the disclosure relates to a multitask browser control (sometimes referred to herein as a surfmark control), which when activated by a user, causes the browser to perform multiple tasks. The multiple tasks may include opening a currently viewed resource currently being displayed in a first browser window or tab, in a separate browser tab or window, while also executing a back command in the first browser window or tab, so that a previous resource is displayed in the first window or tab, or while also executing a forward command in the first browser window or tab, so that a forward resource is displayed in the first window or tab.

Optionally, activation of the multitask browser control also causes the URL or other locator or identifier for the currently viewed webpage (being viewed prior to the back navigation being performed) to be added to a temporary and/or a non-temporary bookmark list. The temporary and/or a non-temporary bookmark list may be maintained and displayed in a browser tab or window, in a toolbar (e.g., docked over or towards the top or bottom of the browser user interface, displayed on a left side, right side, or bottom of the browser user interface, displayed in the browser tab of the browsing session, or displayed over a webpage being displayed by the browser, etc.). Optionally, in response to a user action (e.g., a closing of the browser or activation of a temporary bookmark delete control), the temporary bookmarks are deleted.

By way of example, the multitask browser control may be native to the browser or may be added as a browser plugin (a program that adds functionality to the browser). The browser plugin may optionally be downloaded from a network resource, such as a website or an online software store.

Thus, with a single activation (e.g., a single click, which may be in the form of a touch or gesture) of the multitask browser control, a user can perform multiple operations, including, for example, any combination of 2, 3, or 4 of at least the following functions:
Back navigation function or forward navigation function;
Open currently displayed resource (e.g., a webpage displayed at the time the multitask control is activated) in a new browser tab or window;
Create temporary bookmark for currently displayed resource (the resource displayed at the time the multitask control is activated);
Highlight listing for currently displayed resource in previous resource listing a plurality of resources (e.g., webpages).

Thus, the multitask browser control may be used to reduce the number of user inputs needed to navigate and keep track of resources.

An aspect of the disclosure is a computer-implemented method of browser navigation, the method comprising: after a browser has navigated from a first webpage to a second webpage, the first webpage containing a plurality of links including a link to the second webpage, detecting that a user has activated, with a single activation, a first multitask browser control while the browser is displaying the second webpage in a first window, wherein the first window may be tabbed or non-tabbed; in response to detecting that the user has activated the first multitask browser control while the browser is displaying the second webpage in the first window: automatically causing the first webpage to be displayed in the first window, and automatically causing the second webpage to be loaded to a second window, wherein the second window may be tabbed or non-tabbed, and wherein the second window does not obscure the first window in the absence of subsequent user interaction with the browser.

An aspect of the disclosure is a computer storage system comprising a non-transitory storage device, said computer storage system having stored thereon executable program instructions that direct a computer system to at least: after a browser has navigated from a first resource to a second resource, the first resource containing a plurality of links including a link to the second resource, detect that a user has activated, with a single activation, a first multitask browser control while the browser is displaying the second resource in a first window, wherein the first window may be tabbed or non-tabbed; in response to detecting that the user has activated the first multitask browser control while the browser is displaying the second resource in the first window: cause the first resource to be displayed in the first window, and cause the second resource to be loaded to a second window, wherein the second window may be tabbed or non-tabbed.

An aspect of the disclosure is a system, comprising: a network interface; a computing system comprising one or more computing devices; a computer storage system comprising a non-transitory storage device, said computer storage system having stored thereon executable program instructions that direct the computer system to at least: instantiate a network stack instantiate a browser; enable the browser to access remote resources via the network stack and network interface; after the browser has navigated from a first resource to a second resource, the first resource containing a plurality of links including a link to the second resource, detect that a user has activated, with a single activation, a first multitask browser control while the browser is displaying the second resource in a first window, wherein the first window may be tabbed or non-tabbed; in response to detecting that the user has activated the first multitask browser control while the browser is displaying the second resource in the first window: cause the first resource to be displayed in the first window, and cause the second resource to be loaded to a second window, wherein the second window may be tabbed or non-tabbed.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example environment.

FIG. 2 illustrates an example process.

FIGS. 3A-3G illustrate example user interfaces.

FIGS. 4A-4F illustrate example user interfaces.

FIG. 5 illustrates another example process.

### DETAILED DESCRIPTION OF EMBODIMENTS

Disclosed herein are systems and methods for browsing.

One of the most commonly used web browser controls is the back control. A conventional back control merely enables a user to instruct the browser to navigate back to a previous resource. However, when surfing the Internet, a user often views a set of links (e.g., presented in an online news site, an ecommerce site, an entertainment site, in search results, etc.), sees a first link that may be of interest, selects the first link, and in response the browser then requests, receives, and displays the resources corresponding to the first link. The user may be interested in the displayed resources, but may navigate backwards to the set of links to determine if there are other resources the user may be interested in. The user may then select a second link and the process repeats. However, the user may have lost track of the first link, which the user was still interested in and wants to revisit, and so the browsing experience may be overly frustrating and time consuming.

By way of further example with respect to search results (although similar examples include user navigation with respect to an online news site, an ecommerce site, an entertainment site, etc.), conventionally, when a user views search results from a search engine the user experience may be as follows. The search results displayed by a browser via a search results webpage may be limited to ten website listings related to their query, wherein a given listing includes a website link and a very brief (e.g., two sentence) description of the corresponding website or an excerpt of content from the website. The user chooses a first website listing in the search results, and clicks the link to access the corresponding first website via the user browser. On many occasions, the user may not want to extensively read the first website to decide if that is the best website for what the user is looking for without reviewing a few other websites listed in the search results to determine if one of the other websites may be better for the user's purposes. The user may see some information or items on the first website that the user wants to reference later, but nonetheless, the user may decide to click the back control and review another link in the search results that may serve them better.

After reviewing the search results again, the user selects a second website listing that appears to be of interest. The web browser accesses and displays the corresponding second website. The user briefly reviews the second website to determine if the second website may be a better choice, and again the user does not want to extensively read the second website to decide if that is the best website for what the user is looking for without reviewing a few other websites listed in the search results to determine if one of the other websites may be better for the user's purposes. The user may see some information or items on the second website that the user want to reference later, but nonetheless, the user again may decide to click the back control and review a third link in the search results that may serve them better.

This process may be repeated multiple times before the user decides which is the best website for the user. By way of illustrative example, after briefly reviewing ten websites, the user may decide that websites two and six were the best, and the user may now want to go back to previously viewed websites two and six. Conventionally, the links in the search results will change color if the user has selected them. However, if the user selected ten links, it will often be difficult for the user to remember which links were for sites of the most interest. So the user may have to guess which websites were the websites the user thought were of the most interest, and the user may have to navigate back and forth to re-locate those websites.

Aspects of the disclosure address some or all of the web browsing deficiencies discussed above.

As similarly discussed above, an example aspect of the disclosure relates to a multitask browser control (sometimes referred to herein as a surfmark control), which when activated by a user (e.g., via a single click/selection), causes the browser to perform multiple tasks. The multiple tasks may include, by way of example, opening a currently viewed resource (sometimes referred to herein as a “marked” resource when the multitask browser control is activated while the resource is displayed in the browser), such as a first webpage currently being displayed in a first browser window or tab, in a separate browser tab or window, while also executing a back command in the first browser window or tab, so that a previous resource is displayed in the first window or tab (or while also executing a forward command in the first browser window or tab, so that a forward resource is displayed in the first window or tab). Thus, optionally, when the user activates the multitask browser control, the previous webpage (or other resource) is displayed in the currently viewed tab or window, and the “marked” webpage (or other resource) is opened in a window or tab that does not overlay or block the previous webpage (and the content of which may optionally not be visible at all until the tab or window is selected by the user).

Optionally, the user can specify via a settings/preferences control whether activation of the multitask browser control will cause the currently viewed webpage to be displayed in another tab or to be displayed in another browser window. Optionally, the user can specify via a settings/preferences control whether activation of the multitask browser control will cause the currently viewed webpage to be displayed in another tab or to be displayed in another browser window while the previous page is to be displayed in the currently viewed tab or window, or whether the currently viewed webpage is to be displayed in the current tab or window, and that the previous page is to be displayed in a new tab or window.

Optionally, activation of the multitask browser control also causes the URL or other locator and/or identifier for the first webpage to be added to a temporary bookmark list. The temporary bookmark list may be maintained and displayed in a browser tab or window, in a toolbar (e.g., docked towards the top or bottom of the browser user interface or displayed on a left or right side of the browser user interface), and/or otherwise. Optionally, in response to a user action (e.g., a closing of the browser or activation of a temporary bookmark delete control), the temporary bookmarks are deleted. The temporary bookmark features may optionally be performed by a dedicated control instead of or in addition to the multitask control.

Optionally, activation of the multitask browser control or other control may cause the browser to highlight the links to the “marked” webpages of a search result on the previous webpage (e.g., by using a specific color, such as orange, or by changing the font, and/or via an icon), to further ease finding resources previously identified by the user as being of interest. Optionally, the user may specify via a settings/preference control the form and/or color of the highlighting. The highlighting features may optionally be performed by a dedicated control instead of or in addition to the multitask control.

Optionally, the multitask browser control may be positioned adjacent to the conventional browser back control, and may display an icon distinguishing the multitask browser control from the back control or forward control, where the icon optionally indicates the functionality of the multitask browser control.

Optionally, two or more multitask controls maybe provided by a browser, each of which performs at least two or more of the following functions in response to single user activation (e.g., a single click):
Back navigation function or forward navigation function;
Open currently displayed resource (e.g., a webpage displayed at the time the multitask control is activated) in a new browser tab or window;
Create temporary or non-temporary bookmark for currently displayed resource (the resource displayed at the time the multitask control is activated);
Highlight listing for resource displayed at the time the multitask control is activated in previous resource listing a plurality of resources (e.g., webpages) that includes a listing for the marked resource.

Thus, the multitask browser control may be used to reduce the number of user inputs needed to navigate and keep track of resources.

An additional optional user benefit, is that the user may not have to wait for each webpage visited to load because the loading may be performed while the back or forward command is being executed simultaneously in response to the user activation of the multitask control.

Optionally, the browser (which may include a multitask browser control plugin) maintains a history of the resources “marked” using the multitask browser control. For example, the history may be maintained in a tab, a tabbed page, a file, a menu, a toolbar, or otherwise. The user may access and review the history, and may revisit a marked resource by selecting the corresponding history entry (which may include a link to the resource). Optionally, the marked webpage history may be accessed by the user for future reference even after the browser has been closed (e.g., via system preferences of the application).

By way of example, the multitask browser control may be native to the browser or may be added as a browser plugin (a program that adds functionality to the browser). The browser plugin (also known by other names, such as extension, widget, or module) may optionally be downloaded from a network resource, such as a website or an online software store. The browser may be a standalone browser, or the browser may be incorporated into an application providing significant other functionality.

The network resource may be a document, such as a webpage, a vector-based document, an audio/image media resource (e.g., a video, a photograph, an audio file, etc.), and/or other resource. A given network resource may include a graphical representation of hyperlinked resources residing in disparate parts of a computer network.

Another optional technique enabling the user to select a resource for future reference is as follows. If a resource, such as a webpage is loaded in a tabbed window, the user may drag the tab outside of the tab parameters (e.g., by dragging a tab downward outside of the form field where the tab is located) which causes a new browser session with that webpage to open, optionally or not overlaying, in whole or in part, the current browser session (the webpage being displayed when the drag operation is performed), wherein the new browser session automatically navigates back to the previous resource (e.g., the previous webpage). If the new browser session overlays the initial browser session, the user may still minimize or move the new web browser session out of the way to access and view the initial web browser session. The user may then activate the back control.

Optionally, a “resource mark” control may be provided on a search results page next to a previously viewed resource link via which the user can “mark” the link and/or open the link in a new tab.

Another optional technique enabling the user to select a resource for future reference is as follows. The user may drag a tab over to another spot on the browser tab bar, which causes the currently viewed webpage to be opened in a new tab without inhibiting the initial web browser session from opening that webpage as the currently viewed webpage. The initial browser session may also be commanded to navigate back to the previous webpage.

Optionally, a “marked” resource may be displayed in an initial browser with multiple “sub-browsers” displaying within a “master” browser, where the surfmark may be configured to open the marked resource in a sub-browser within the master browser.

By way of illustrative example, the functionality provided by the multitask browser control may be beneficial to a user when reviewing multiple websites returned in a search in response to a query. Using the functionality provided by the multitask browser control, the user can reference and re-reference previously viewed webpages (e.g., displayed in tabs or windows opened by the browser in response to the user activation of the multitask browser control) quickly, with one control activation (e.g., one click) while still being able to navigate backwards to a previous webpage. This technique will greatly reduce the number of user clicks and time when looking for information.

In addition to optionally being used for navigating search results, the functionality provided by the multitask browser control may be generally beneficial for a user viewing, via the browser, a given webpage or website (e.g., a news website, an online catalog website, an entertainment website, etc.) and searching through different webpages provided in the navigation bar of the website or linked to by a given website webpage, where the user wants to mark specific webpages for later review. For example, the user may find useful information on the website's “About” page, “News” page, and “Info” page, and so would like them to be displayed in another window or tab for later review, while the user is continuing to browse other pages of the website. When the user is at a given webpage of interest, the user may activate the multitask browser control (e.g., using a single click or other single action), and the webpage will be loaded and be ready to view in another tab or window when the user is ready to review the webpage more thoroughly, while also navigating the browser back to the previous webpage of the browsing session.

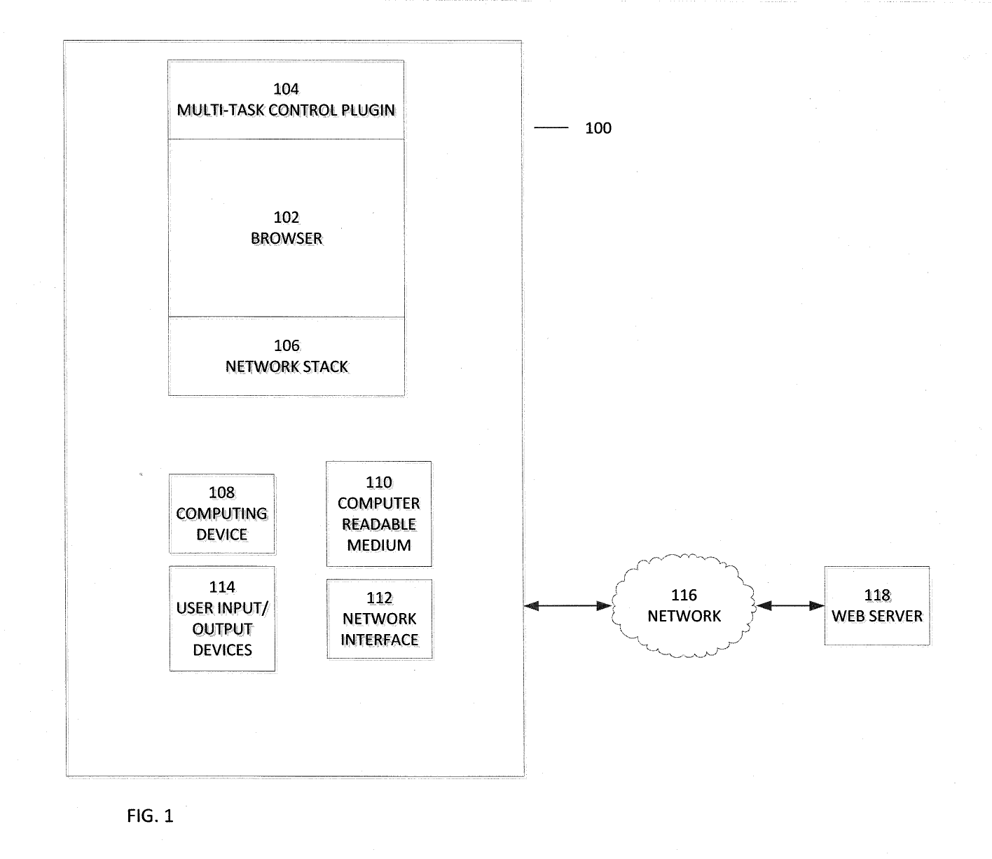

FIG. 1 illustrates an example environment which may support the multitask browser control. A computing system 100 (e.g., a desktop computer, a laptop computer, a tablet computer, a smart phone, a smart watch, a networked television, a portable or set-top networked game console, etc.) is illustrated. The computing system 100 includes hardware and may include software. The system 100 may include one or more computing devices 108 (e.g., microprocessors, digital signal processors, and/or other types of data processors), computer readable medium (e.g., non-volatile solid state memory, volatile solid state memory, magnetic memory, optical memory, etc.). The system may include one or more user input and output devices 114 (e.g., a display, a speaker, a printer, one or more user input devices (e.g., a touch screen, a keyboard, a mouse, a trackpad, a trackball, a stylus, a microphone, a camera, and/or other input and output devices), a printer, etc. The system may also include one or more network interfaces 112 (e.g., to a data network, a phone network, etc.). The network interface 112 may in turn be coupled to a network 116 (e.g., the Internet and/or other wide area or local area network). The network interface 112 may communicate over the network 116 with one or more remote systems, such as one or more web servers 118 for one or more websites. The remote systems may serve one or more types of resources. The remote systems may include, for example, search system, ecommerce systems, entertainment and news systems, etc.

A network stack 106 (which may be in the form of software hosted by the system 100) may be used to provide other components of the system 100 with access to the network interface 112. The network stack 106 may be used to process network protocol layers. The network stack 106 may be integral to the operating system of system 100 or the network stack 106 may be a separate program.

The system 100 includes a browser 102. The browser 102 may utilize the network stack 106 to access the network interface 112, and to access remote resources over the network 116. The system 100 optionally includes a multitask browser control plugin 104. Optionally, the multitask browser control plugin 104 may have been downloaded from a remote system by a user of the system 100, and then installed for use with the browser 102. Optionally, the multitask browser control functionality may be built-in to the browser 102, rather than separately installed.

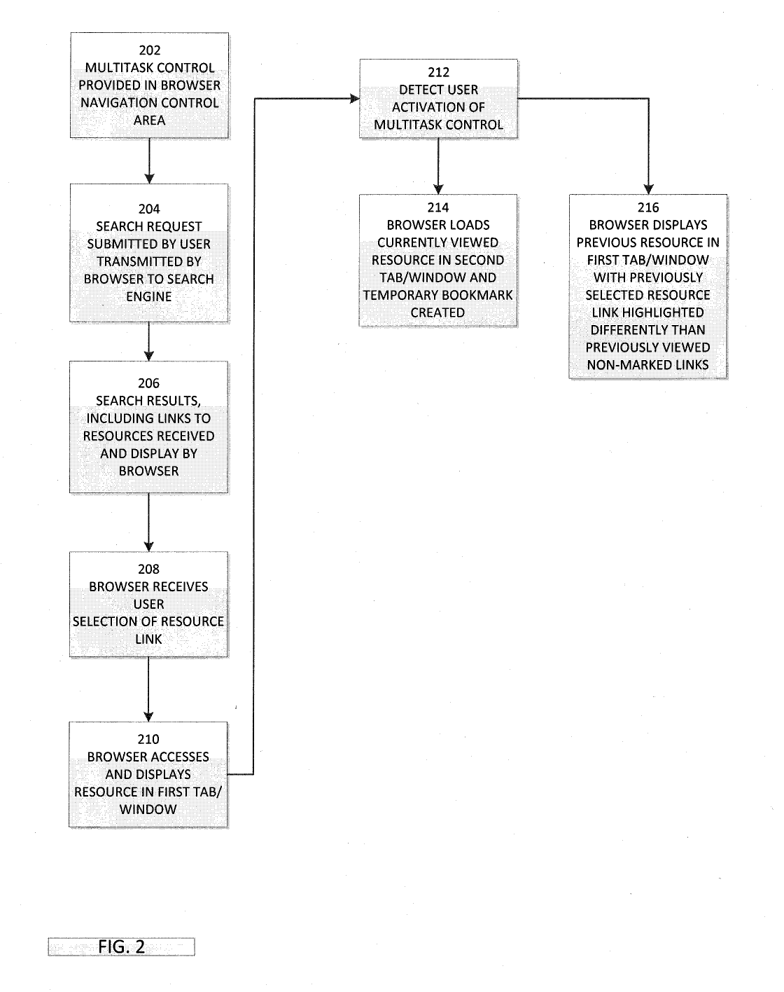

FIG. 2 illustrates an example process in the context of a user performing a search and utilizing the multitask browser control. However, it is understood, that the multitask browser control may be utilized for other purposes, such as navigating within an online magazine or catalog, or for generally navigating from resources (e.g., webpages) containing links to other resources.

At block 202, a multitask browser control is provided in a browser. As discussed above, the multitask browser control may be provided via a plugin or the multitask browser control may be integral to the browser. Optionally, the multitask browser control is positioned adjacent to another navigation control, such as a back button. Optionally, two multitask browser controls may be provided. For example, one multitask browser control may, for example, perform a back navigation task as one of its multiple tasks, while a second multitask browser control may, for example, perform a forward navigation task as one of its multiple tasks. Thus, for example, the multitask browser control may perform two or more of the functions discussed herein in response to a single user activation (e.g., a single click), greatly reducing the number of user inputs needed to navigate online resources.

At block 204, the browser transmits a user search query (e.g., received via a search text field displayed via a first tabbed window or a non-tabbed window, or otherwise) to a search engine. At block 206, the search results, including links to resources identified by the search, are displayed by the browser in the first tab or window. At block 208, the browser detects that the user has selected one of the links in the search results. At block 210, the browser accesses, over a network from a linked-to system, the resource (e.g., webpage) corresponding to the selected link, and displays the resource in the first tab or window. At block 212, the browser and/or plugin detects that the user has activated the multitask browser control. At block 212, the browser loads the currently viewed resource in a second tab or window (without obscuring the currently displayed tab or window). Optionally, a temporary bookmark for the selected link is created. At block 214, the browser displays the previous resource (the search results in this example) in the first tab or window. Optionally, the previously selected link is highlighted differently than other links that have not been “marked” using the multitask browser control.

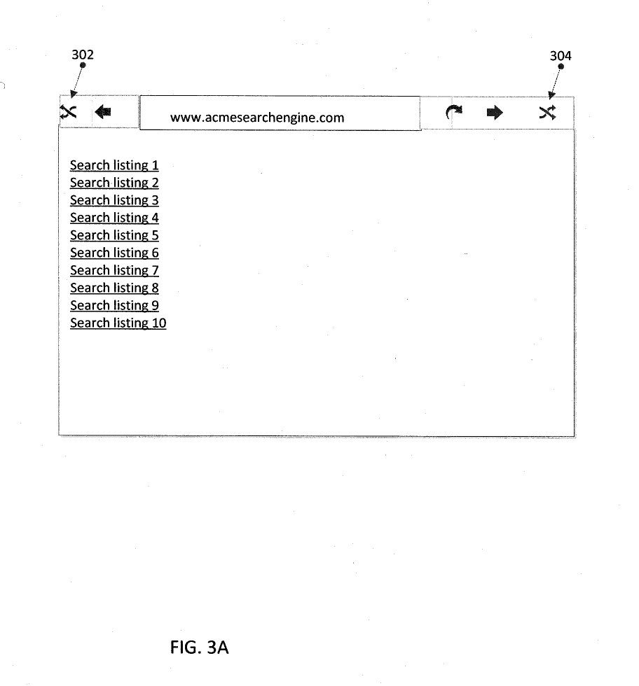

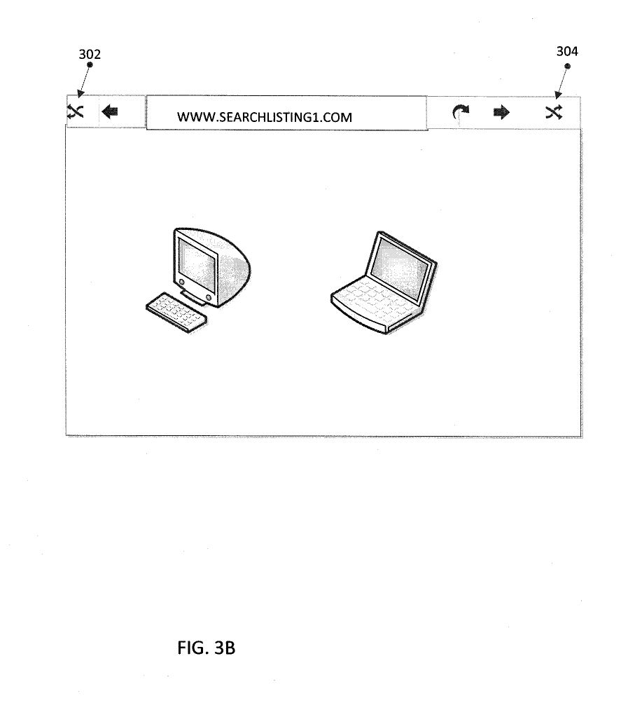

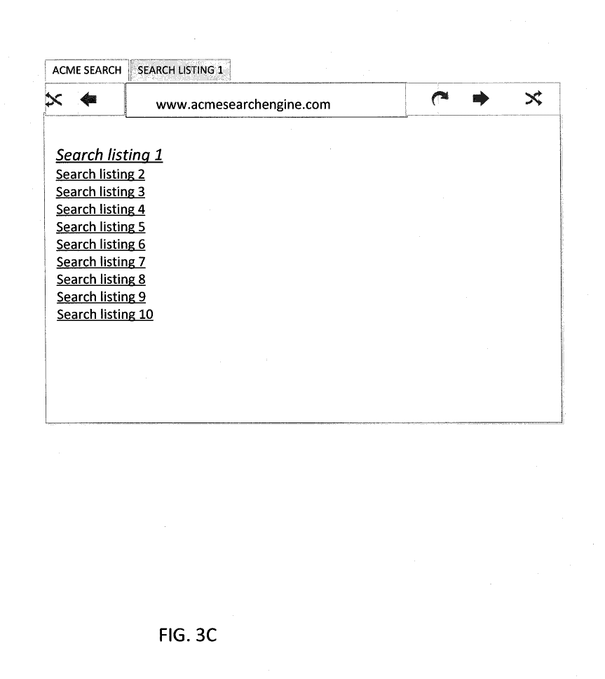

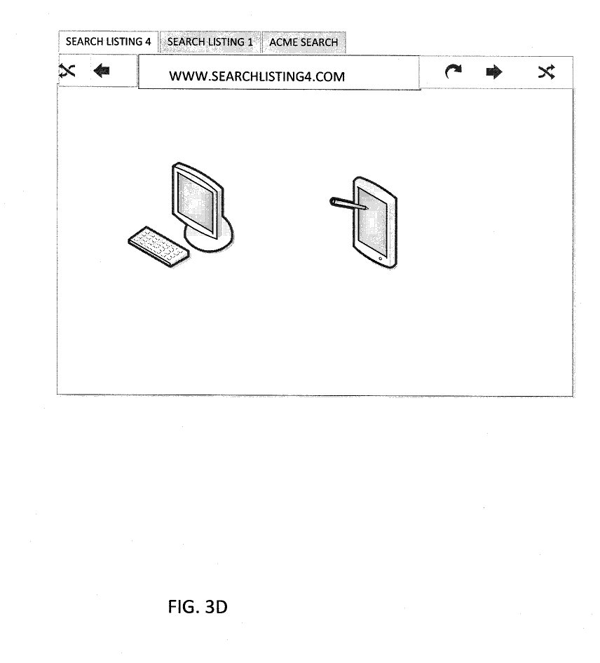

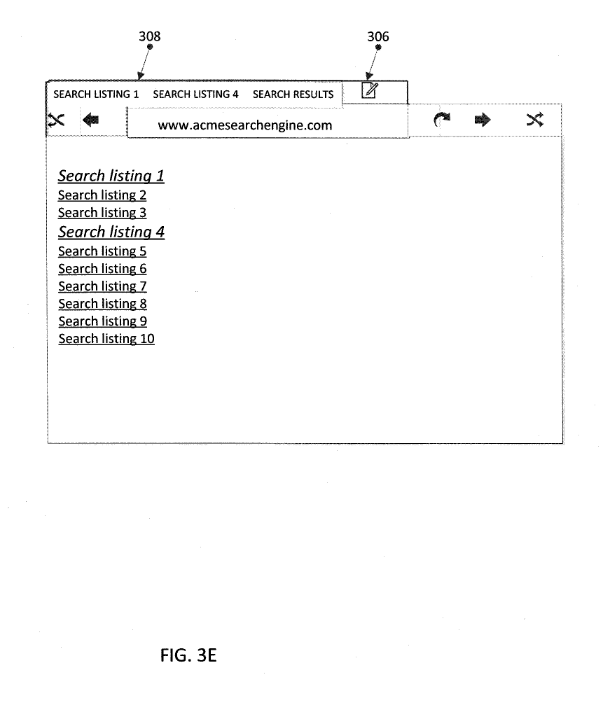

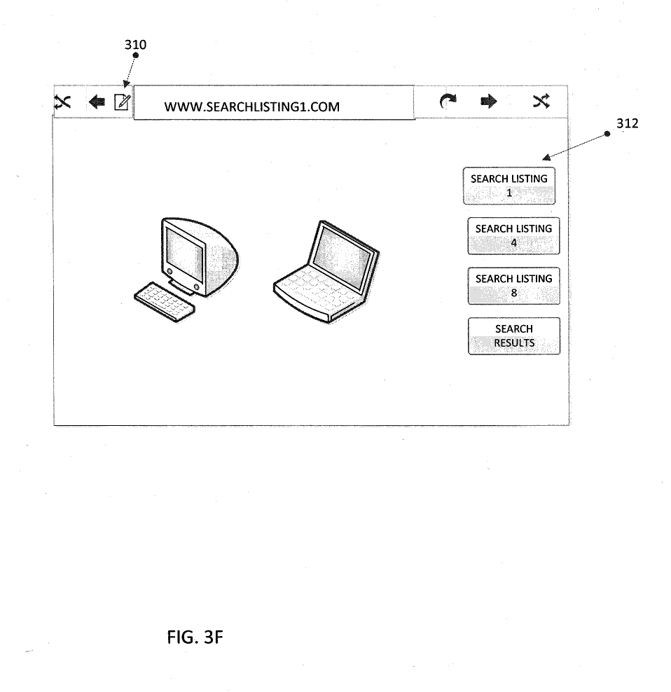

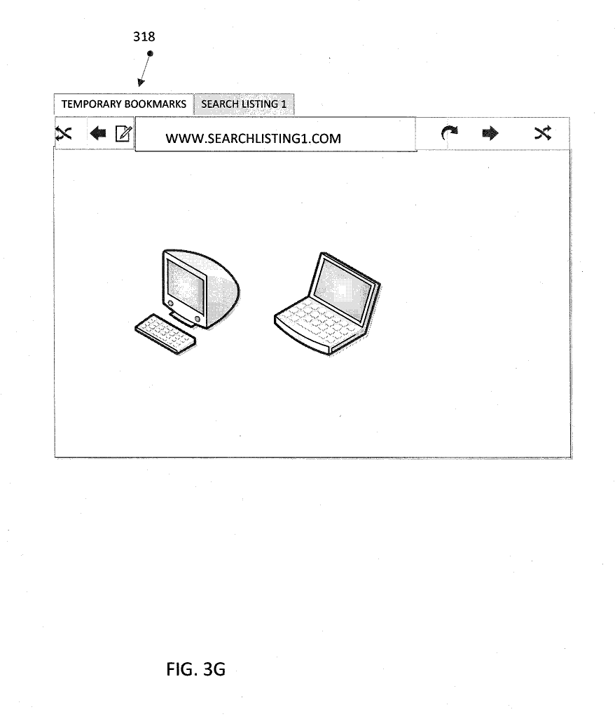

Example user interfaces will now be described with reference to FIGS. 3A-3G. FIG. 3A illustrates a browser displaying the results of a user search. The search results in this example include multiple search result listings (e.g., for computer equipment, or other product, service, or information) which comprise links to corresponding resources such as a webpage. This example includes two multitask browser controls, a back multitask browser control 302 and a forward multitask browser control 304. Optionally, only one of the foregoing multitask browser controls may be provided.

If the user selects the Search listing 1 link in this example, the browser accesses and presents the corresponding resource (e.g., webpage). If the user does not find the displayed webpage useful, the user may activate the conventional back control, and the browser would navigate back to the previous resource (the search results in this example) in a conventional manner (without automatically creating a tab or window for the selected link). However, if the user thinks he may want to later refer back to the Search listing 1 resource (which may be, in this example, a webpage of an ecommerce site selling computers), the user may activate the back multitask browser control 302.

If the user activates the back multitask browser control 302, the current resource may be loaded into another tab or window (marked “SEARCH LISTING 1” in this example), while the previous resource (the search results in this example) may be displayed in the current window or tab, as illustrated in FIG. 3C. Optionally, in response to the user activating the back multitask browser control 302, the selected link may be displayed in the search results with special highlighting (e.g., with an indicative color, font, underlining, or otherwise) to show the user has “marked” the link as of interest.

The user may select another link in the search results. In this example, the user selects Search listing 4 (which, in this example, may correspond to a second ecommerce site selling computer equipment) and the browser accesses and presents the corresponding resource (e.g., webpage), as illustrated in FIG. 3D. In this example, there is a tab for the previously “marked” link. Thus, the user can easily refer back to the Search listing 1 page by clicking on the corresponding tab, without having to navigate back to the search results illustrated in FIG. 3A. Optionally, a tab is also generated for the search result listing so that the user can easily access the search result listing without having to use navigation controls.

If the user activates the back multitask browser control 302, the Search listing 4 resource may be loaded into another tab or window (marked “SEARCH LISTING 4” in this example), while the previous resource (the search results in this example) may be displayed in the current window or tab, as illustrated in FIG. 3E. In addition, the tab for Search listing 1 is still present. Optionally, if a user decides a given resource is no longer of interest, the user may close the tab for that resource (e.g., by clicking on a close tab control provided on the tab or otherwise). Optionally, in response to the user activating the back multitask browser control 302, the SEARCH LISTING 4 link may also be displayed in the search results with special highlighting (e.g., with an indicative color, font, underlining, or otherwise) to show the user has “marked” the link as of interest.

As noted above, the user may instruct the browser to add a particular resource link as a temporary bookmark. This may be performed as one of the functions of the multitask browser control, or a separate temporary bookmarking control may be provided. FIG. 3F illustrates an example browser with a dedicated temporary bookmark control 310. In the illustrated example, the user had previously activated the temporary bookmark control 310 when viewing the search results, Search listing 1, Search listing 4, and Search listing 8. Temporary bookmarks 312 are displayed within the browser window (e.g. hovering over or to the side of a displayed webpage, optionally in a translucent manner). The user may access the resources (e.g., webpages) corresponding to the temporary bookmarks by selecting a corresponding bookmark, and the browser will then display the resource in the current tab or window with the temporary bookmarks still displayed. FIG. 3G illustrates the temporary bookmarks 318 displayed in a temporary bookmark area, without overlaying the displayed resource.

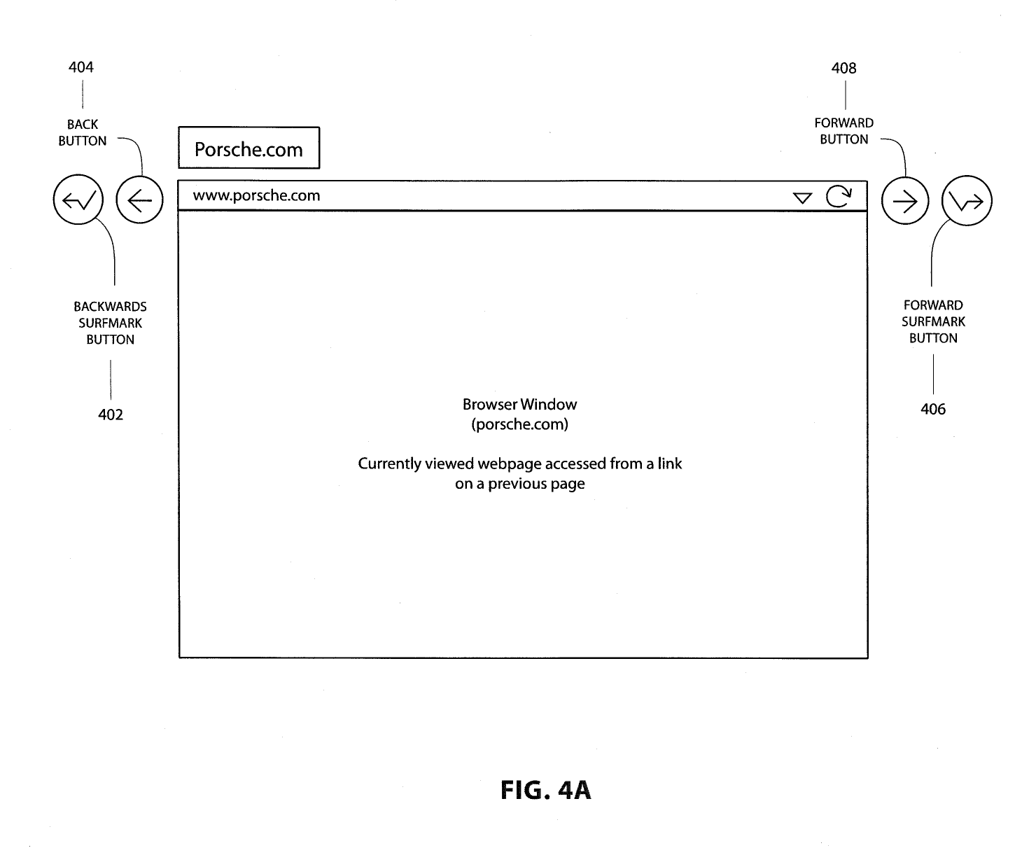

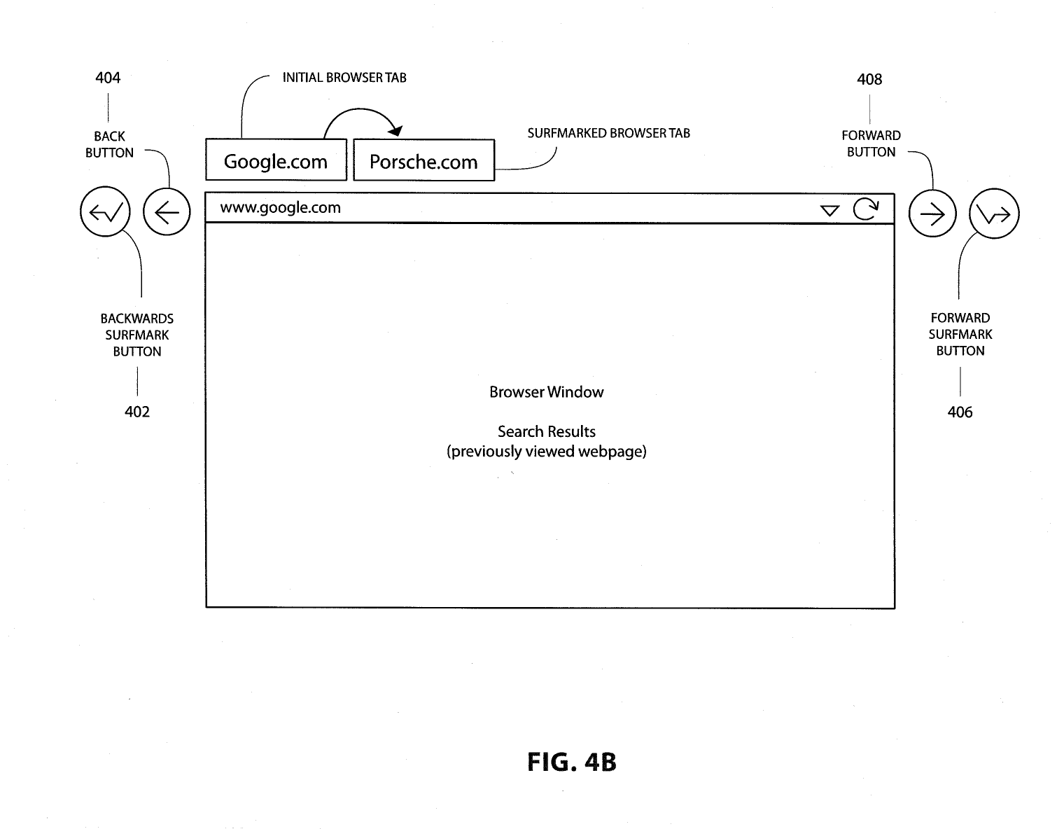

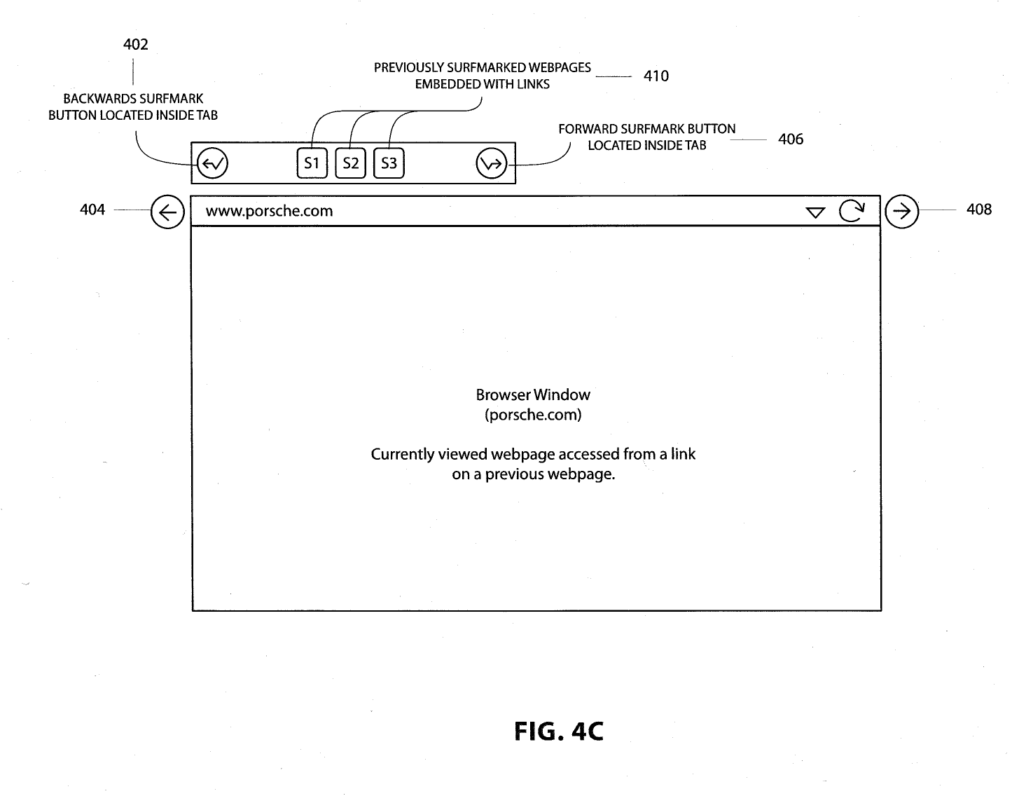

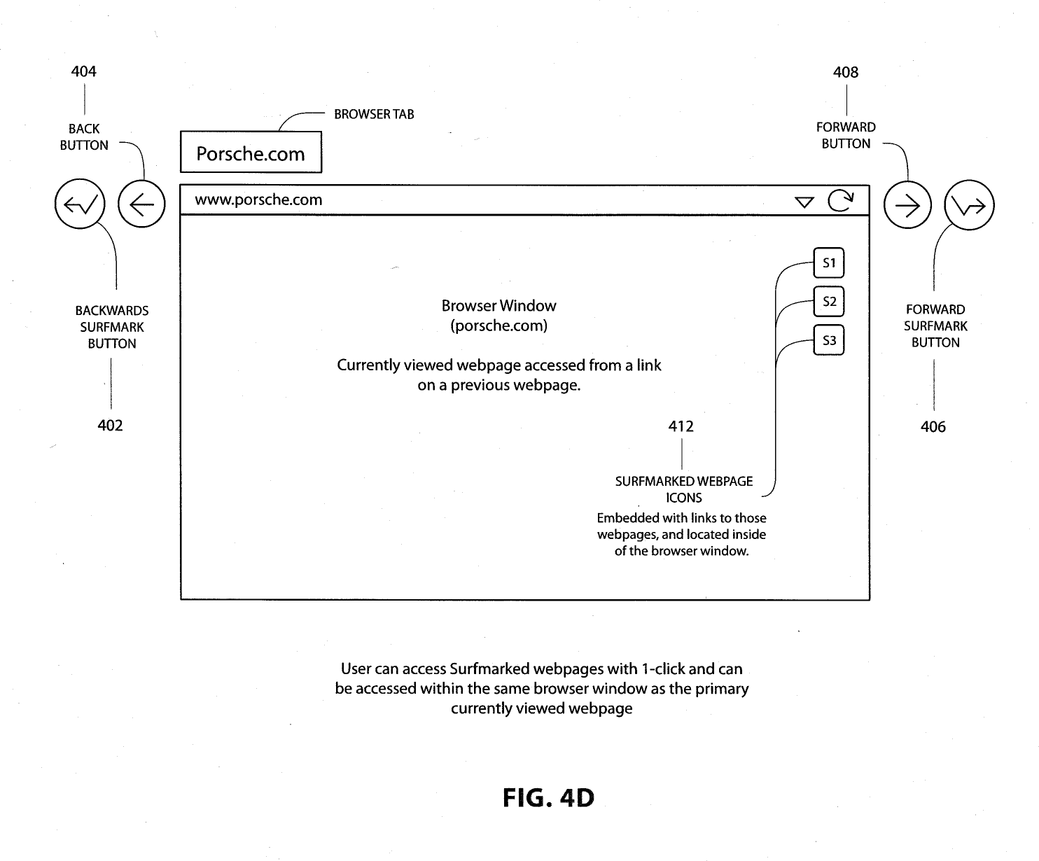

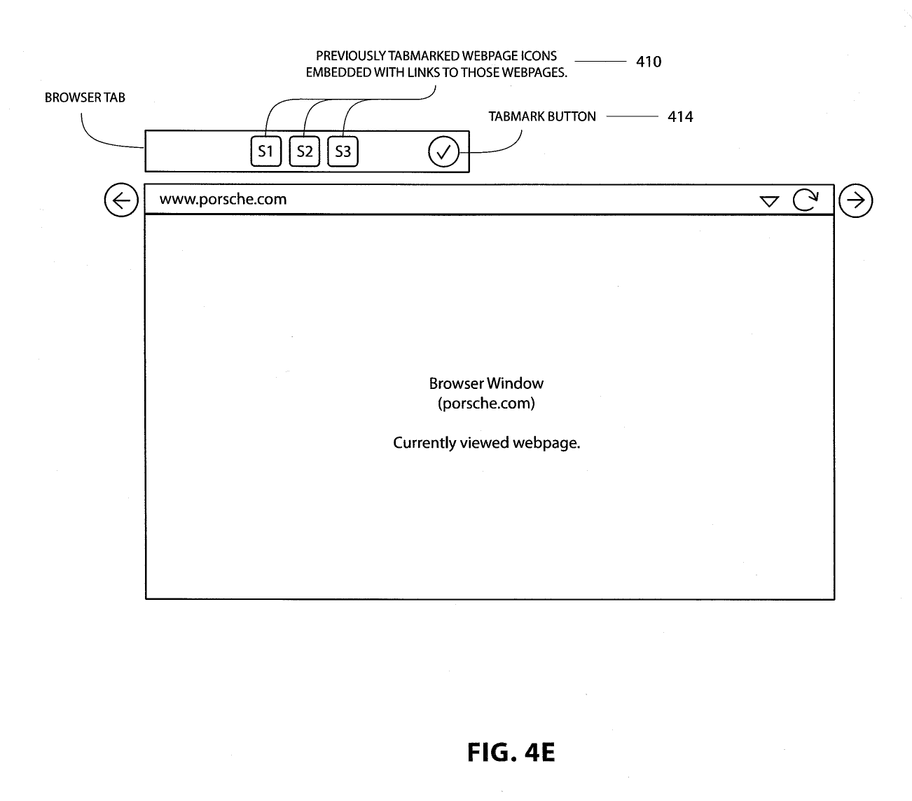

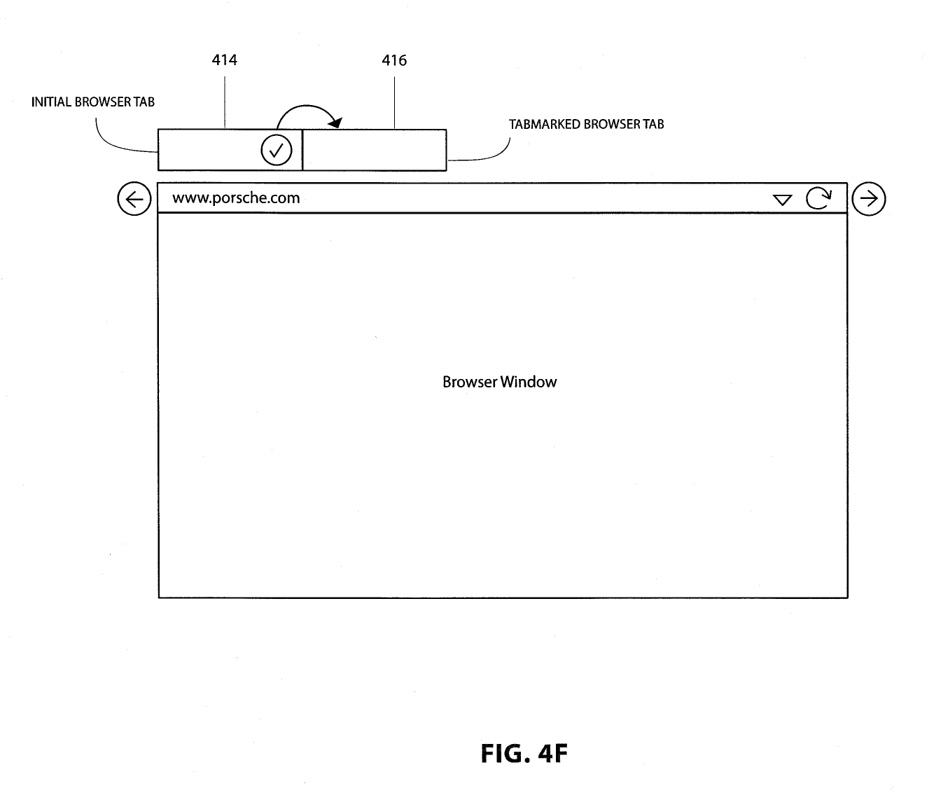

FIG. 4A illustrates another example web browser user interface with a conventional back navigation control 404, a backward multitask browser navigation control (“backwards surfmark”) 402, a conventional forward navigation control 408, a forward multitask browser navigation control (“forward surfmark”) 406. The resource currently being displayed was accessed by the user selecting a corresponding link on a previous resource (e.g., a webpage from an online news site, an ecommerce site, an entertainment site, in search results, etc.).

If the user activates the backward multitask browser navigation control 402 (e.g., with a single click), the example user interface illustrated in FIG. 4B is presented. The resource displayed in FIG. 4A is now loaded in a new tab (without being displayed), while the previously displayed resource is displayed in the current tabbed window. Thus, with a single activation of the backward multitask browser navigation control 402, the resource that was being displayed is loaded into a new tab, and the browser navigates back to the previous resource in the displayed window.

FIG. 4C illustrates an example web browser user interface in which previously “marked” resources (which were marked by the user activating the backward multitask browser navigation control 402 or the forward multitask browser navigation control 406 while the resource was displayed to the viewer) are displayed as icons 410 on a tab. The icons are embedded with links so that when selected by the user, the web browser will navigate to the corresponding resource. Thus, in this example, the user can access marked resources (e.g., webpages) within the same browser session, without requiring a separate browser session/window. Optionally, the backward multitask browser navigation control 402 and the forward multitask browser navigation control 406 are positioned in the same tab/toolbar as the icons 410.

FIG. 4D illustrates an example web browser user interface in which previously “marked” resources (which were marked by the user activating the backward multitask browser navigation control 402 or the forward multitask browser navigation control 406 while the resource was displayed to the viewer) are displayed as icons 412 within the browser window, optionally overlaying the resource being displayed. The icons may be translucent so as not to completely obscure the underling content. The icons are embedded with links so that when selected by the user (e.g., with a single activation, such as a single click), the web browser will navigate to the corresponding resource. Thus, in this example, the user can access marked resources (e.g., webpages) within the same browser window as the currently viewed resource.

FIG. 4E illustrates an example web browser user interface in which previously “marked” resources (which were marked by the user activating the tabmark control 414 while the resource was displayed to the viewer) are displayed as icons 410 on a tab. In this example, optionally activation of the tabmark control 414 does not cause the browser to navigate backwards or forwards. This enables the user to mark a page for later reference without navigating away from that page. The icons are embedded with links so that when selected by the user, the web browser will navigate to the corresponding resource. Thus, in this example, the user can access marked resources (e.g., webpages) within the same browser session, without requiring a separate browser session/window. Optionally, the backward multitask browser navigation control 402 and the forward multitask browser navigation control 406 are not provided in this user interface.

FIG. 4F illustrates an example web browser user interface in which previously “marked” resources (which were marked by the user activating the tabmark control 414 while the resource was displayed to the viewer) are loaded in separate tabbed windows 416. In this example, optionally activation of the tabmark control 414 does not cause the browser to navigate backwards or forwards. This enables the user to mark a page for later reference without navigating away from that page. The icons are embedded with links so that when selected by the user, the web browser will navigate to the corresponding resource. Thus, in this example, the user can access marked resources (e.g., webpages) within the same browser session, without requiring a separate browser session/window. Optionally, the backward multitask browser navigation control 402 and the forward multitask browser navigation control 406 are not provided in this user interface.

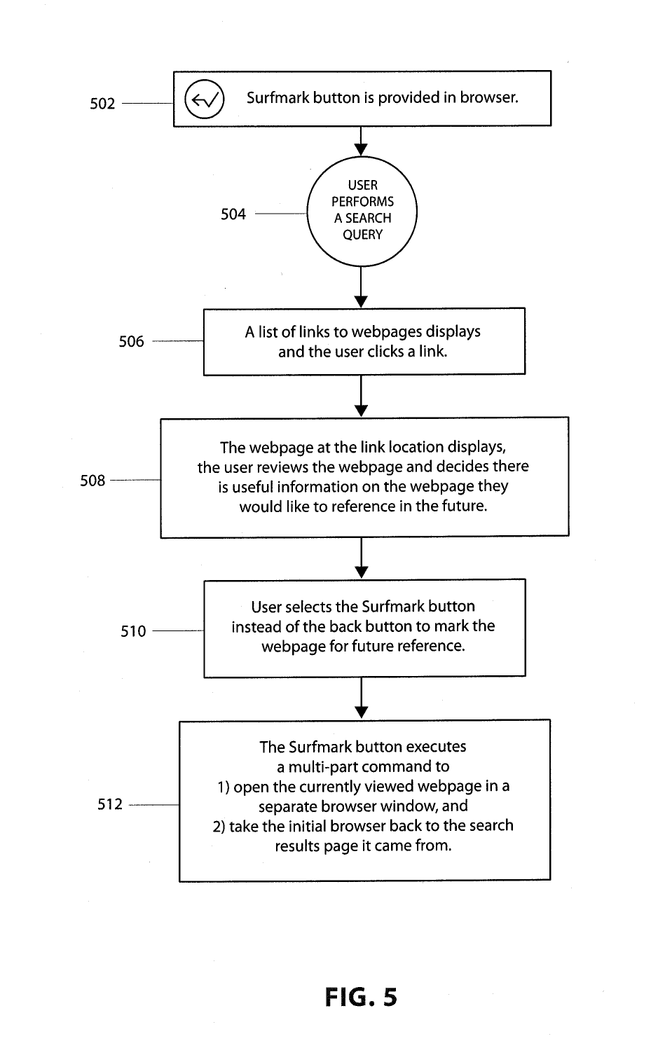

FIG. 5 illustrates an example process. At block 502, a multitask control (referred to as a “surfmark button”) is provided in a browser. Optionally, the multitask browser control is positioned adjacent to a conventional navigation control, such as a back navigation control. At block 504, the user submits a search query, receives the results via the browser, and selects a link included in the results. At block 506, the browser accesses and displays the webpage corresponding to the selected link. At block 508, the user reviews the webpage, and decides that the webpage contains useful content that the user would like to re-access in the future. At block 510, the user selects the multitask browser control (referred to as a “surfmark button”) with a single activation, and not the conventional back navigation control, to mark the webpage for future reference. At block 512, the browser executes the commands associated with the multitask browser control, including, in this example, opening the currently viewed web page in a separate browser window or tabbed window (without displaying the separate browser window or tabbed window unless the user selects the separate browser window or tabbed window), and navigates back to the search results.

Thus, a multitask browser control and process is described that provides enhanced browser navigation. It is understood, that while the foregoing process describes a multitask browser control that, when activated performs a back task as one of its tasks, the multitask browser control may similarly configured to perform a forward task (navigating the web browser forward a resource, such as a webpage, as one of its tasks.

While the phrase “click” may be used with respect to a user selecting a control or the like, other user inputs may be used, such as voice commands, text entry, gestures, etc. For example, the system may optionally enable the user to “mark” a resource by moving the user's finger so as to “draw” a checkmark shape (although optionally, no checkmark is actually displayed) on a currently displayed resource (e.g., webpage) using a touch screen device (e.g., on a mobile phone, tablet computer, etc.). When the system detects the user has drawn the checkmark over the resource, the system may perform at least two or more of the following functions:
1. Back navigation function or forward navigation function;
2. Open currently displayed resource (e.g., a webpage displayed at the time the multitask control is activated) in a new browser tab or window;
3. Create temporary or non-temporary bookmark for currently displayed resource (the resource displayed at the time the multitask control is activated);
4. Highlight listing for resource displayed at the time the multitask control is activated in previous resource listing a plurality of resources (e.g., webpages) that includes a listing for the marked resource.

Thus, a gesture may be used as the multitask browser control.

Optionally, links and/or corresponding icons for marked resources may be stored by a marked resources manager. The marked resources manager may be associated with a control, which when activated, causes the links and/or icons corresponding to the marked resources to be displayed. The links and/or icons may be displayed in a list, grid, or other format. In response to detecting that the user has selected a given marked resource link and/or icon, the system causes a browser to access and display the corresponding resource. Thus, a user may access multiple marked resource links with a single activation of the marked resources manager control. This technique may be particularly useful for mobile devices with touch displays, but may also be used for non-mobile devices.

Optionally, a single control may selectively act as both a conventional navigation control and as a multitask browser control with a single user activation. For example, the system may be configured to sense how long or how hard (e.g., with what level of pressure) a user is pressing on a control (where the pressing may be on a touch screen) and based on the sensing determine with to perform the acts of the conventional control or of the multitask browser control. For example, a single control may be configured to act as both a conventional back navigation control and as a multitask browser control depending on the user input. By way of example, if the system detects that the user has pressed on the back navigation control for less than a specified period of time (e.g., less than 0.5 seconds, 1 second, 2 seconds, or other time), the system treats the activation as a conventional back navigation command and simply displays the previous resource. If the system detects that the user has pressed on the back navigation control for more than a specified period of time (e.g., more than 0.5 seconds, 1 second, 2 seconds, or other time), the system treats the activation as a multitask control action and performs multiple tasks as described elsewhere herein. This technique may be particularly useful for mobile devices with touch displays, but may also be used for non-mobile devices.

By way of further example, the system may be configured to translate the user pressing, within a browser window or a browser address field, for more than a specified period of time (e.g., more than 0.5 seconds, 1 second, 2 seconds, or other time), as a multitask control command, and may in response perform multiple tasks as described elsewhere herein. This technique may be particularly useful for mobile devices with touch displays, but may also be used for non-mobile devices.

While the phrase “webpage” may be used with respect to a resource accessed by or displayed by a browser, it is understood that the browser may similarly access and display other resource types.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method of browser navigation, the method comprising:
after a browser has navigated from a first webpage to a second webpage, the first webpage containing a plurality of links including a link to the second webpage,
detecting that a user has activated, with a single activation, a first multitask browser control while the browser is displaying the second webpage in a first window, wherein the first window may be tabbed or non-tabbed;
in response to detecting that the user has activated the first multitask browser control while the browser is displaying the second webpage in the first window:
automatically causing the first webpage to be displayed in the first window, and
automatically causing the second webpage to be loaded to a second window, wherein the second window may be tabbed or non-tabbed, and wherein the second window does not obscure the first window in the absence of subsequent user interaction with the browser.

2. The computer-implemented method as defined in claim 1, the method further comprising:
adding a temporary bookmark corresponding to the second webpage in response to the user activating the first multitask browser control; and
automatically deleting the temporary bookmark at least partly in response to the user closing the browser.

3. The computer-implemented method as defined in claim 1, the method further comprising:
adding a bookmark corresponding to the second webpage in response to the user activating the first multitask browser control; and
displaying the bookmark in a page, a tab, or a toolbar.

4. The computer-implemented method as defined in claim 1, the method further comprising highlighting the link to the second webpage in the first webpage in response to the user activating the first multitask browser control.

5. The computer-implemented method as defined in claim 1, wherein causing the second webpage to be loaded to a second window further comprises causing the second webpage to be loaded to the second window in response to a pre-specified user preference.

6. The computer-implemented method as defined in claim 1, wherein the first multitask browser control is instantiated by a first multitask browser control plugin.

7. The computer-implemented method as defined in claim 1, wherein the first multitask browser control is integral to the browser.

8. The computer-implemented method as defined in claim 1, wherein the first webpage comprises a webpage of an online catalog, a webpage of an online news resource, or a webpage comprising search results.

9. The computer-implemented method as defined in claim 1, wherein detecting that a user has activated, with a single activation, a first multitask browser control further comprises detecting that the user has made a first gesture over a first area of the first webpage.

10. The computer-implemented method as defined in claim 1, wherein detecting that a user has activated, with a single activation, a first multitask browser control further comprises detecting that the user has pointed at a conventional browser control for more than a first period of time.

11. The computer-implemented method as defined in claim 1, wherein detecting that a user has activated, with a single activation, a first multitask browser control further comprises detecting that the user has pointed at a browser address field for more than a first period of time.

12. The computer-implemented method as defined in claim 1, wherein the browser is hosted by a mobile device.

13. A computer storage system comprising a non-transitory storage device, said computer storage system having stored thereon executable program instructions that direct a computer system to at least:
after a browser has navigated from a first resource to a second resource, the first resource containing a plurality of links including a link to the second resource,
detect that a user has activated, with a single activation, a first multitask browser control while the browser is displaying the second resource in a first window,
wherein the first window may be tabbed or non-tabbed;
in response to detecting that the user has activated the first multitask browser control while the browser is displaying the second resource in the first window:
cause the first resource to be displayed in the first window, and
cause the second resource to be loaded to a second window, wherein the second window may be tabbed or non-tabbed.

14. The computer storage system as defined in claim 13, wherein the executable program instructions are further configured to direct a computer system to:
add a bookmark corresponding to the second resource in response to the user activating the first multitask browser control; and
automatically delete the bookmark at least partly in response to the user closing the browser.

15. The computer storage system as defined in claim 13, wherein the executable program instructions are further configured to direct a computer system to:
add a bookmark corresponding to the second resource in response to the user activating the first multitask browser control; and
display the temporary bookmark in a page, a tab, or a toolbar.

16. The computer storage system as defined in claim 13, wherein the executable program instructions are further configured to direct a computer system to highlight the link to the second resource in the first resource in response to the user activating the first multitask browser control.

17. The computer storage system as defined in claim 13, wherein the executable program instructions are further configured to direct a computer system to cause the second resource to be loaded to the second window in response to a pre-specified user preference.

18. The computer storage system as defined in claim 13, wherein the executable program instructions comprise plugin instructions configured to instantiate the first multitask browser control.

19. The computer storage system as defined in claim 13, wherein the second window does not, without further user action, obscure the first window.

20. The computer storage system as defined in claim 13, wherein the first resource comprises a webpage of an online catalog, an online news resource, or a webpage comprising search results.

21. The computer storage system as defined in claim 13, wherein the detection that a user has activated, with a single activation, a first multitask browser control further comprises detecting that the user has made a first gesture over a first area of the first webpage.

22. The computer storage system as defined in claim 13, wherein the detection that a user has activated, with a single activation, a first multitask browser control further comprises detecting that the user has pointed at a conventional browser control for more than a first period of time.

23. The computer storage system as defined in claim 13, wherein the detection that a user has activated, with a single activation, a first multitask browser control further comprises detecting that the user has pointed at a browser address field for more than a first period of time.

24. A system, comprising:
a network interface;
a computing system comprising one or more computing devices;
a computer storage system comprising a non-transitory storage device, said computer storage system having stored thereon executable program instructions that direct the computer system to at least:
instantiate a network stack;
instantiate a browser;
enable the browser to access remote resources via the network stack and network interface;
after the browser has navigated from a first resource to a second resource, the first resource containing a plurality of links including a link to the second resource,
detect that a user has activated, with a single activation, a first multitask browser control while the browser is displaying the second resource in a first window, wherein the first window may be tabbed or non-tabbed;
in response to detecting that the user has activated the first multitask browser control while the browser is displaying the second resource in the first window:
cause the first resource to be displayed in the first window, and
cause the second resource to be loaded to a second window, wherein
the second window may be tabbed or non-tabbed.

25. The system as defined in claim 24 wherein the executable program instructions are further configured to direct the computer system to:
add a temporary bookmark corresponding to the second resource in response to the user activating the first multitask browser control; and
automatically delete the temporary bookmark at least partly in response to the user closing the browser.

26. The system as defined in claim 24, wherein the executable program instructions are further configured to direct the computer system to:
add a bookmark corresponding to the second resource in response to the user activating the first multitask browser control; and
display the bookmark in a page, a tab, or a toolbar.

27. The system as defined in claim 24, wherein the executable program instructions are further configured to direct the computer system to highlight the link to the second resource in the first resource in response to the user activating the first multitask browser control.

28. The system as defined in claim 24, wherein the executable program instructions are further configured to direct the computer system to cause the second resource to be loaded to the second window in response to a pre-specified user preference.

29. The system as defined in claim 24, wherein the executable program instructions comprise plugin instructions configured to instantiate the first multitask browser control.

30. The system as defined in claim 24, wherein the second window does not, without further user action, obscure the first window.
